(19) United States
(12) Patent Application Publication
(10) Pub. No.: US 2012/0002902 A1
(43) Pub. Date: Jan. 5, 2012

(54) IMAGE INTERPOLATING METHOD BASED ON DIRECTION DETECTION AND DEVICE THEREOF

(75) Inventors: Jin Zhou, Beijing (CN); Qifeng Liu, Beijing (CN)

(73) Assignee: POWERLAYER MICROSYSTEMS HOLDING INC., George Town, Grand Cayman (KY)

(21) Appl. No.: 12/680,521

(22) PCT Filed: Sep. 25, 2008
(86) PCT No.: PCT/CN08/72503

§ 371 Date: Mar. 18, 2011

(30) Foreign Application Priority Data
Sep. 28, 2007 (CN) 200710152055.4

(51) Int. Cl. G06K 9/03

(52) U.S. Cl. 382/309

(57) ABSTRACT

An accurate image interpolation method based on direction detection and device thereof are disclosed. The image interpolation method based on direction detection includes the following steps: step a, detecting an interpolating direction of a pixel to be processed to obtain interpolating direction information of the pixel; step b, utilizing the result of detecting an interpolating direction to interpolate the pixel to be processed. Another step a′ between the step a and step b is also included: utilizing the interpolating direction information of the pixel adjacent to the pixel to be processed for correcting the result of step a; at step b, utilizing the detection result of interpolating direction corrected at the step a′ to interpolate the pixel to be processed.

### TECHNICAL AREA

This invention is involved in digital image processing technology, especially a method of image interpolation.

### TECHNICAL BACKGROUND

In digital image processing, image interpolation processing is often needed, for example, the image interpolation operation is needed in de-interlacing for interlaced image, or scaling image into different size.

Currently, there are three image interpolation methods widely adopted: pixel copying, quadratic linear interpolating and direction filtering, of which the direction filtering is also called direction interpolation and used for obtaining interpolation result of pending pixel. Main method of the direction filtering is to detect the interpolation direction of the pending pixel first, then to interpolate for the pending pixel on the basis of the interpolation direction. Thus, when the direction filtering method is adopted, detection accuracy of the interpolation direction (or robustness of the direction detection) is a foundation of accuracy of subsequent interpolation results. In practical application, noises and differences between images are inevitable, errors often occur in direction detection results, which induce inaccuracy in final interpolation results.

### DETAILS OF THIS INVENTION

The purpose of this invention is to provide an accurate direction detection based image interpolation method by solving error problem in interpolation direction judgment caused by external interference to improve the accuracy of interpolation results.

Another purpose of this invention is to offer a device for implementing the method as described above.

Technical idea of this invention is, after detecting the interpolation direction, using interpolation direction information of pixels adjacent to the pending pixel to correct result of the interpolation direction detection, hence to obtain more accurate result of interpolation direction and utilize this result in processing subsequent interpolations, and furthermore to select suitable pending pixels to conduct smooth process for it.

### Technical Scheme of this Invention is as Follows

An image interpolation method based on direction detection includes steps as follows: Step a) detecting an interpolation direction of a pending pixel to obtain interpolation direction information of the pixel; Step b) interpolating for the pending pixel by utilizing the detected result of the interpolation direction. A Step a′ between the Step a and Step b is also included: correcting the result obtained in the Step a by utilizing the interpolation direction information of the pixels adjacent to the pending pixel; at the Step b, interpolating for the said pending pixel by utilizing the detected result of the interpolation direction, which has been corrected at the Step a′.

The Step a′ includes steps as follows: giving correction parameters to the adjacent pixels respectively on the basis of interpolation direction information of the pixels adjacent to the pending pixel; processing the interpolation direction information, obtained in the Step a, of the pending pixel and the correction parameters by using correction rule to obtain the corrected interpolation direction information of the pending pixel.

The adjacent pixels of the pending pixel are eight pixels located around the pending pixel, and interpolation directions of the eight pixels are already known; these eight pixels are classified according to the known interpolation directions, and correction parameters of the adjacent pixels are set according to the obtained corresponding classifications.

In a plane coordinate system divided into four quadrants, the interpolation direction is represented by a straight line passed through the origin; the classifications are defined as follows:

Classification 0: the straight line is in vertical or horizontal direction;
Classification 1: the straight line falls into first and third quadrants simultaneously;
Classification 2: the straight line falls into second and fourth quadrants simultaneously.

The correction rule is the algebraic sum of the interpolation direction information of the pending pixel and the correction parameters.

After calculating the algebraic sum, applying truncation function to the result of the algebraic sum, the role of this truncation function is to make the result of the algebraic sum within the predefined scope of the interpolation direction information, and the result processed by truncation function is the corrected interpolation direction information for the pending pixel.

Step c following after the Step b is also included: selectively smoothing the pending pixel according to the correlation between the pixels adjacent to the pending pixel.

The correlation said in the Step c refers to comparison results between absolute difference of different pixels' luminance values and preset values. The smoothing process will be applied to the pending pixel if the correlation satisfies the following three conditions:
1) Min_{diff}<tnd₁;
2) MaX_{diff}>thd₂;
3) D_{gh}>thd₃;

Where thd₁ to thd₃ are thresholds; min_{diff} is a minimum value of absolute difference values between luminance values of two pixels adjacent to a pending pixel; max_{diff} is a maximum value of absolute difference values between luminance values of two pixels adjacent to a pending pixel; D_{gh} is a absolute difference value of luminance values between two adjacent pixels at the interpolation direction of a pending pixel.

Low-pass filtering method with coefficients of 1-2-1 is adopted in the said smoothing process.

A device for realizing the image interpolation method based on direction detection includes: interpolation direction detection unit, correction unit and interpolation unit, the said interpolation direction detection unit is connected with the correction unit, and the correction unit is also linked with the interpolation unit; the interpolation direction detection unit is used for obtaining interpolation direction information of a pending pixel, the correction unit is used for correcting result of the interpolation direction detection unit, and the interpolation unit is used for interpolation of pixels according to corrected interpolation direction information obtained in the correction unit.

The correction unit also includes a correction parameters acquisition sub-unit and a correction result acquisition sub-unit; the correction parameters acquisition sub-unit gives correction parameters by utilizing the interpolation direction information of the pending pixel obtained in the interpolation direction detection unit, and transmits the correction parameters to the correction result acquisition sub-unit; the correction result acquisition sub-unit processes, by utilizing correction rule, the interpolation direction information of the pending pixel obtained in the interpolation direction detection unit and the correction parameters obtained in the correction parameters acquisition sub-unit.

The device also includes a smoothing unit; the smoothing unit connected with the interpolation unit is used to judge correlation between pixels on results obtained by the interpolation unit, and to selectively smooth specific pixels according to judgment result.

### Technical Results of this Invention

Judgment of human vision on edge direction in an image is not limited to one pixel, instead an area is used as a judgment target, that is, a group of pixels within an area is integrated for judging and the edge direction is judged by utilizing correlation between pixels that constitute the edge. This invention exactly utilizes such principle to correct interpolation direction of the pending pixel by using interpolation direction information of pixels adjacent to the pending pixel. It can effectively correct interpolation direction detection result, decrease or eliminate the influence of external interference, such as noise and etc., on the interpolation direction detection to obtain more accurate interpolation direction information and to establish accurate foundation for its following interpolation calculations.

This invention, after finishing interpolation step, smoothes pixels satisfied certain conditions. Jaggy phenomenon will, in some cases, appear on image after interpolation processing, and such phenomenon will be more obvious especially on some oblique edge or oblique line, and even broken line will occur sometimes. After selectively smoothing, such phenomenon of jaggy and broken line will be obviously eliminated. The reason for adopting the selectively smoothing process in this invention is based on that most of pixels processed via the said interpolation have been correctly interpolated, and only a few of pixels with potential defects are needed to be smoothed in the smoothing process step, so that it can avoid false correction and assure image quality.

The implementation of the device realizing this invention can obtain processing result of image in higher quality.

### EXPLANATIONS ON ATTACHED FIGURES

FIG. 1 is a flow chart of the interpolation method of this invention;

FIG. 2 is a pixel relationship chart when conducting an interpolation direction correction;

FIG. 3 is an area partition of a space around a pending pixel by using assistant interpolation direction correction;

FIG. 4 is a relationship chart between pixels for additional explaining the smoothing;

FIG. 5 is a schematic diagram of the device for realizing the image interpolation method based on direction detection;

FIG. 6 is a schematic diagram of the smoothing unit;

FIG. 7 is a schematic diagram of the correction unit;

FIG. 8 is a schematic diagram of the 1-2-1 low-pass filter;

FIG. 9 is an image processed by common image interpolation method;

FIG. 10 is the final image processed by the image interpolation method of this invention.

### EMBODIMENT

This section will explain in detail the technical scheme of this invention in combination with the attached figures.

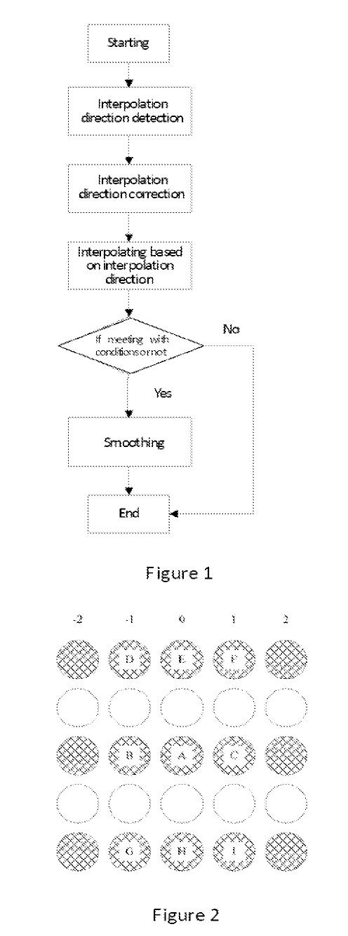

FIG. 1 reveals steps of the image interpolation method based on direction detection disclosed in this invention, explanations will be given in each step.

### (1) Detection of the Interpolation Direction

In this step, interpolation direction information will be detected first for an input pending pixel.

Here, the pending pixel interpolation direction is detected by using first order differential method, namely, calculating the difference of luminance values between pixels adjacent to a pending pixel. If the difference is smaller, possibility for the direction to be an interpolation direction is higher; otherwise if the difference is larger, possibility for the direction to be an interpolation direction is lower. Generally, a minimum value is selected from them and used as a value of the pixel interpolation direction.

Many similar current technologies can also be used for the interpolation direction detection, but are not further explained here.

### (2) Correction of the Interpolation Direction

In this step, result of the interpolation direction detection is corrected. As an interpolation direction correction method, interpolation direction information of pixels adjacent to a pending pixel is utilized to correct the interpolation direction of the pending pixel. As shown in FIG. 2, point filled with grids is pending pixel, blank point is original pixel (namely, pixel with complete information), digits marked at upper part in row where pixels D, E, F are located are used to indicate coordinates for pixel interpolation direction, of which pixel A is current pending pixel, and thus pixels B, C, D, E, F, G, H and I are eight pixels adjacent to pending pixel. When correcting interpolation direction, preliminary interpolation directions of nine pixels A-I have been obtained via the former interpolation direction detection phase, preliminary interpolation directions of eight pixels B-I are used as correction factors for interpolation direction of pixel A.

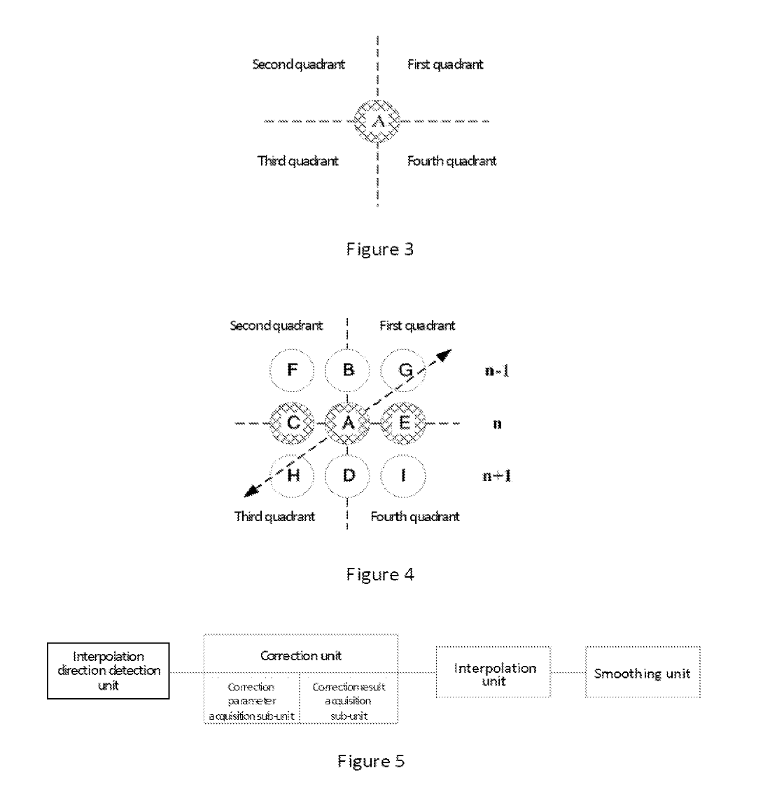

As shown in FIG. 3, based on pixel A as a center, space around pixel A is divided into four quadrants by using horizontal axis and vertical axis, interpolation direction is represented by a straight line passing through the origin. Preliminary interpolation direction of eight pixels B-I belongs to one of three classifications below:

Classification 0: Interpolation direction (straight line passed through the origin) is in vertical or horizontal direction;
Classification 1: Interpolation directions (straight line passed through the origin) simultaneously fall into first and third quadrants;
Classification 2: Interpolation directions (straight line passed through the origin) simultaneously fall into second and fourth quadrants.

After eight pixels B-I are attributed to the three classifications above, correction parameters are respectively given to eight pixels B-I according to their distance to the pending pixel A, as shown in the table below.

| | Correction parameter | | |
|---|---|---|---|
| Adjacent pixels | Classification 0 | Classification 1 | Classification 2 |
| B, C | 0 | 1 | −1 |
| E, H | 0 | 0.5 | −0.5 |
| D, F, G, I | 0 | 0.3 | −0.3 |

The correction parameters are preset experienced values and directly used in the method of this invention. The correction parameters are proportionally changed according to the marked interpolation direction coordinate unit, for example, the parameters in the table above could be multiplied by a value a corresponding to the marked interpolation direction coordinate unit, a is 1 in this embodiment. Rule for setting up the correction parameter is: weight of the interpolation direction of an adjacent pixel with shorter distance to the pending pixel is larger; weight of the interpolation direction of an adjacent pixel with longer distance to the pending pixel is smaller.

Correcting the preliminary interpolation direction of a pending pixel by using the correction parameters in the table above, its formula (correction rule) is as follows:

D′_{A}=f(D_{A},K)

Where function f (D_{A}, K) can be calculated by using simple sum, namely, f (D_{A}, K)=D_{A}+K; D′_{A} is the corrected interpolation direction of pixel A; D_{A} is the preliminary interpolation direction of pixel A obtained via interpolation direction detection; k is the correction parameter, correction parameters corresponding to eight pixels B-I are all engaged in the correction calculation, namely, k represents the sum of correction parameters corresponding to eight pixels B-I.

It can also select pixels at outside of the eight pixels B-I as a correction basis in the correction calculation mentioned above, this method is similar to the one explained above, but its correction parameter is decreased along with the increase of distance between pixel A and corresponding pixel.

Attention shall be paid on that: final correction result D′_{A} shall be within the range of the interpolation direction detection, in this embodiment, truncation function is adopted to process D′_{A}, D′_{A} is restricted within range of the interpolation direction detection, when D′_{A} is larger than upper limit of the range of interpolation direction detection, D′_{A} is set to upper limit; when D′_{A} is smaller than lower limit of the range of interpolation direction detection, D′_{A} is set to lower limit.

### (3) Interpolating According to the Interpolation Direction

After obtaining the corrected interpolation direction of a pending pixel, the pixel on this direction can be interpolated and calculated by using several current technologies, such as low-pass filtering or median filtering.

### (4) Smoothing Process

Jaggy phenomenon will appear on image after interpolation processing under certain conditions, and such phenomenon will be more obvious especially on some finer oblique edge or oblique line, and even broken line will occur sometimes. Therefore, it is necessary to smooth the interpolated image (it can also be called as connecting process for the case of broken line, but in this patent it is integrally called as smoothing process). Because jaggy phenomenon only appears on oblique direction in the interpolated image, smoothing process will not be performed on pixels with vertical or horizontal interpolation direction.

Via processing of the former three steps, interpolation results of the most pixels in a image are accurate, and only the interpolation result of pixels meeting certain conditions may have jaggy phenomenon, therefore, selecting and processing these pixels meeting certain conditions can purposefully optimize interpolation result of an image, and can simultaneously avoid incorrect optimization caused by smoothing the image pixel by pixel.

The pixels and interpolation directions listed in the FIG. 4 explain how to select pixels that are necessary to be smoothed. In the FIG. 4, row n−1 and n+1 are the original pixels, row n is the pixel pending for interpolating, and the interpolation direction of the pending pixel A is represented by double-arrow dot-line as shown in the FIG. 4. Three absolute values are calculated respectively, absolute difference value in luminance D_{bc} of pixel B and pixel C, absolute difference value in luminance D_{de} of pixel D and pixel E, and absolute difference value in luminance D_{gh} of pixel H and pixel G. Smaller value min_{diff} and larger value max_{diff} are obtained via comparing D_{bc} and D_{de}. If three conditions mentioned below are met simultaneously then the smoothing process shall be conducted:
1) Min_{diff}<thd₁;
2) MaX_{diff}>thd₂;
3) D_{gh}>thd₃;

Where thd₁ to thd₃ are preset thresholds, they can be experienced values obtained via experiments. Comparison result between the absolute different value in luminance and the preset value is also called correlation. The pending pixel shall be smoothed if correlation of pixels adjacent to the pending pixel meets the conditions described above. Purpose of the above judgment conditions is to assure sufficient correlation between two pixels adjacent to the pending pixel (pixels' absolute difference value in luminance is smaller than the preset threshold), simultaneously, the correlation of other adjacent pixels is weaker (pixels' absolute difference value in luminance is bigger than the preset threshold). Only in this way, wrong smoothing or wrong connecting will not happen.

Smoothing process is to smooth and filter pending pixel A and two pixels corresponding to smaller min_{diff}, for example, a low-pass filtering method can be adopted by using pixel A as a center with coefficients of 1-2-1 to obtain the final interpolation value of pixel A.

FIG. 5 reveals a device for realizing the image interpolation method based on direction detection. The device includes: interpolation direction detection unit, correction unit, interpolation unit and smoothing unit. The interpolation direction detection unit is connected with the correction unit; the correction unit is also linked with the interpolation unit; the interpolation unit is connected with the smoothing unit. The interpolation direction detection unit is used for obtaining interpolation direction information of a pending pixel; the correction unit is used for correcting result of the interpolation direction detection unit; the interpolation unit is used for interpolating pending pixel according to corrected interpolation direction information obtained in the correction unit; smoothing unit is used for judging the correlation of pixels adjacent to a pending pixel and smoothing the pending pixel according to the judgment result.

The correction unit also includes a correction parameters acquisition sub-unit and a correction result acquisition sub-unit. The correction parameters acquisition sub-unit gives correction parameters to pixel by utilizing the interpolation direction information of a pending pixel obtained in the interpolation direction detection unit, and transmits the correction parameters to the correction result acquisition sub-unit. The correction result acquisition sub-unit processes, by utilizing correction rule, the interpolation direction information of the pending pixel obtained in the interpolation direction detection unit and the correction parameters obtained in the correction parameter acquisition sub-unit. Principle of the correction unit is shown in the FIG. 7, where D_{B}-D_{I} represent the interpolation directions of eight pixels adjacent to the pending pixel respectively, the corresponding correction parameters of eight pixels can be found by their interpolation direction information in the correction parameter table, and then these parameters obtained are cumulated and the cumulated result is transmitted to the correction result acquisition sub-unit, up to now, the task of the correction parameter acquisition sub-unit is finished. The correction result acquisition sub-unit corrects the interpolation direction information D_{A} of the pending pixel A (conducting correction by using interpolation direction information of the eight adjacent pixels) to obtain correction result.

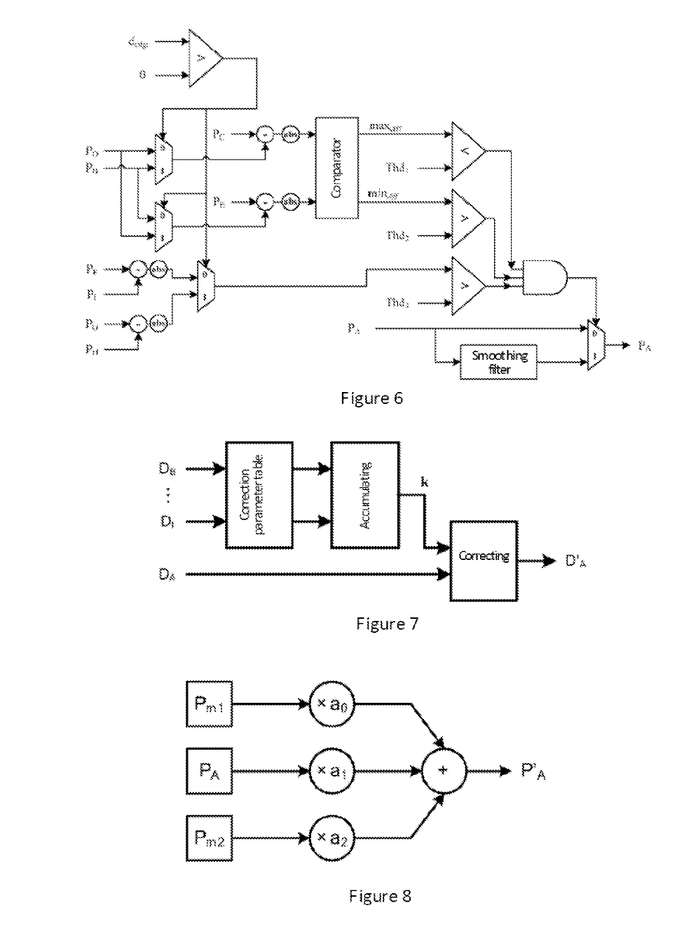

FIG. 6 shows principle of the smoothing unit. When interpolation direction d_{edge} of a pending pixel is in oblique direction, correlation between pixels adjacent to the pending pixel is judged, when the correlation between the said adjacent pixels meets the judgment conditions mentioned in “(4) Smoothing process”, the pending pixel is smoothed, smoothing process is to smooth and filter pending pixel A and two pixels corresponding to smaller min_{diff}, for example, a low-pass filtering method can be adopted by using pixel A as a center with coefficients of 1-2-1, to obtain final interpolated pixel P_{A}′. The above correlation judgment is consistent to “(4) Smoothing process” mentioned above.

FIG. 8 reveals the principle of 1-2-1 low-pass filter. P_{A} is luminance value of pending pixel A, Pₘ₁ and Pₘ₂ are luminance values of two adjacent pixels corresponding to lower value. These three pixel values are multiplied by corresponded coefficients a₁, a₂ and a₃ respectively and then summed up to obtain the final smoothing result P′_{A}. Where coefficients a₁, a₂ and a₃ are the selected normalized value, for example, in the case of 1-2-1 low-pass filter, their value selections are 0.25, 0.5 and 0.25 respectively.

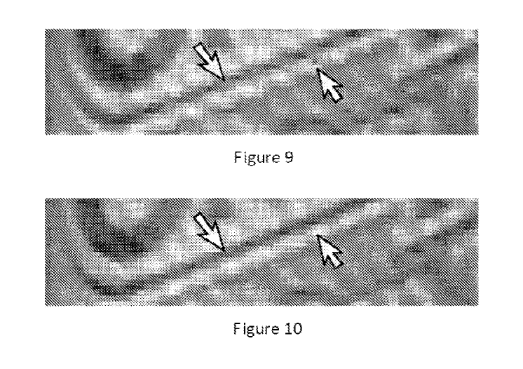

FIG. 9 shows the effect of an image processed by general image interpolation method, broken line and jaggy phenomenon can be seen in the processed image as indicated by arrows, which affects displaying quality of the image. FIG. 10 shows the effect of an image processed by image interpolation method of this invention, in comparison with result of the FIG. 9, that the broken line and jaggy phenomenon existed in general interpolation method have been eliminated and the displaying effect is good.

It shall be indicated that the embodiment mentioned above can make technical staff in this area understand this invention more thoroughly, but this invention will not be limited in any ways. Therefore, though the attached figures and embodiment in this patent explain this patent in detail, the technical staff in this area shall understand that this invention can still be altered or equivalently substituted; however all of technical schemes and modifications that does not break away from spirits and technical essences of this invention shall be covered with claims of this invention patent.

1. An image interpolation method based on direction detection includes steps as follows: a) detecting interpolation direction of a pending pixel to obtain interpolation direction information of the pixel; b) interpolating for the pending pixel by utilizing the detected result of the interpolation direction, it is characterized by that Step a′ is also included between the Step a and the Step b: correcting the result obtained in the Step a by utilizing the interpolation direction information of the pixels adjacent to the pending pixel; in the Step b, interpolating for the pending pixel by utilizing the detected result of the interpolation direction, which has been corrected in the Step a′.

2. An image interpolation method based on direction detection as said in the claim 1, it is characterized by the Step a′ that includes steps as follows: giving correction parameters to the adjacent pixels respectively on the basis of the interpolation direction information of the pixels adjacent to the pending pixel; processing the interpolation direction information, obtained in the Step a, of the pending pixel and the correction parameters by using correction rule, to obtain the corrected interpolation direction information for the pending pixel.

3. An image interpolation method based on direction detection as said in the claim 2, it is characterized by that: the said adjacent pixels of a pending pixel are eight pixels located around the pending pixel, and interpolation directions of the eight pixels are all known already; these eight pixels are classified according to the known interpolation direction, and correction parameters are set accordingly based on the obtained classifications in order to give correction parameters to the adjacent pixels.

4. An image interpolation method based on direction detection as said in the claim 3, it is characterized by that: in a plane coordinate system divided into four quadrants, the interpolation direction is represented by a straight line passed through the origin, the classifications are defined as follows:
Classification 0: the said straight line is in vertical or horizontal direction;
Classification 1: the said straight line falls into first and third quadrants simultaneously;
Classification 2: the said straight line falls into second and fourth quadrants simultaneously.

5. An image interpolation method based on direction detection as said in the claim 4, it is characterized by that: the correction rule is the algebraic sum of the interpolation direction information of the pending pixel and the correction parameters.

6. An image interpolation method based on direction detection as said in the claim 5, it is characterized by that: after calculating the said algebraic sum, processing the result of the algebraic sum by using truncation function, role of this truncation function is to make the result of the algebraic sum lies within the range of the interpolation direction information result, and the result processed by truncation function is the interpolation direction information obtained via correcting the pending pixel.

7. An image interpolation method based on direction detection as said in the claims 1-6, it is characterized by that: Step c following the Step b is also included: selectively smoothing the pending pixels according to correlation between the pixels adjacent to the pending pixel.

8. An image interpolation method based on direction detection as said in the claim 7, it is characterized by that: the correlation said in the Step c refers to comparison results between absolute difference values in luminance of different pixels and preset values.

9. An image interpolation method based on direction detection as said in the claim 8, it is characterized by that: smoothing the pending pixels if the said correlation meets three conditions below simultaneously:
1) Min_{diff}<thd₁;
2) MaX_{diff}>thd₂;
3) D_{gh}>thd₃;
Where thd₁ to thd₃ are preset thresholds; min_{diff} is a minimum value of absolute difference values between luminance values of two pixels adjacent to a pending pixel; max_{diff} is a maximum value of absolute difference values between luminance values of two pixels adjacent to a pending pixel; D_{gh} is a absolute difference value of luminance values between two adjacent pixels at interpolation direction of a pending pixel.

10. An image interpolation method based on direction detection as said in the claim 9, it is characterized by that: low-pass filtering method with coefficients of 1-2-1 is adopted in the said smoothing process.

11. A device for realizing the image interpolation method based on direction detection, it is characterized by that: it includes interpolation direction detection unit, correction unit and interpolation unit, the interpolation direction detection unit is connected with the correction unit and the correction unit is also linked with the interpolation unit; the interpolation direction detection unit is used for obtaining interpolation direction information of a pending pixel, the correction unit is used for correcting result of the interpolation direction detection unit, and the interpolation unit is used for interpolating pixels according to corrected interpolation direction information obtained in the correction unit.

12. A device for realizing the image interpolation method based on direction detection as said in claim 5, it is characterized by that: the correction unit also includes a correction parameter acquisition sub-unit and a correction result acquisition sub-unit; the correction parameters acquisition sub-unit gives correction parameters to pixels by utilizing the interpolation direction information of the pending pixel obtained in the interpolation direction detection unit, and transmits the correction parameter to the correction result acquisition sub-unit; the said correction result acquisition sub-unit processes, by utilizing correction rule, the interpolation direction information of the pending pixel obtained in the interpolation direction detection unit and the correction parameters obtained in the correction parameters acquisition sub-unit.

13. A device for realizing the image interpolation method based on direction detection as said in one of claim 5 or 6, it is characterized by that: it also includes a smoothing unit, the said smoothing unit connected with the interpolation unit is used to judge pixel correlation on results obtained by the interpolation unit, and to selectively smooth specific pending pixels according to judgment result.
